(19) United States
(12) Patent Application Publication
(10) Pub. No.: US 2012/0212942 A1
(43) Pub. Date: Aug. 23, 2012

(54) INDUSTRIAL LED LAMP

(75) Inventors: CHIEN-YUAN CHEN, TAIPEI CITY (TW); YI-CHING CHEN, TAIPEI CITY (TW); YI-SHENG CHEN, TAIPEI CITY (TW)

(73) Assignee: POWER DATA COMMUNICATIONS CO., LTD., TAIPEI COUNTY (TW)

(21) Appl. No.: 13/353,406

(22) Filed: Jan. 19, 2012

(30) Foreign Application Priority Data
Feb. 22, 2011 (TW) 100203174

(51) Int. Cl. F21L 4/02

(52) U.S. Cl. 362/183; 362/184

(57) ABSTRACT

An industrial LED lamp comprises: a housing having at least one compartment and a built-in power supply, and the built-in power supply having a first connecting portion; at least one LED lamp, disposed in the compartment, and having a second connecting portion electrically coupled to the first connecting portion for driving the LED lamp to light up; and a stand, disposed in the compartment, and having a platform at an end of the stand, and a plurality of support legs at the other end of the stand. When use, the LED lamp and the stand are removed from the housing and then connected, and the LED lamp is electrically coupled to the built-in power supply, so that the LED lamp improves the convenience of mobility, installation, use and storage and requires no external electric power for its use.

### CROSS-REFERENCE TO RELATED APPLICATIONS

This non-provisional application claims priority under 35 U.S.C. §119(a) on Patent Application No(s). 100203174 filed in Taiwan, R.O.C. on Feb. 22, 2011, the entire contents of which are hereby incorporated by reference.

### BACKGROUND OF THE INVENTION

1. Field of the Invention

The present invention relates to the field of illumination equipments, in particular to an industrial light emitting diode (LED) lamp structure having a built-in power supply for convenient mobility, installation and use.

2. Description of the Related Art

Spot lights are generally used for a long-distance or a large-area illumination and usually applied for the illumination in construction sites, and thus are also known as lamps for construction works. The lamp for construction generally adopts halogen bulbs or xenon bulbs as its light emitting source to meet the requirements of a large-power and high-lumen illumination. Since this type of light emitting sources has a large volume, the design of the lamp also comes with a large volume as well. In the environment of consuming high power, the service life of this lamp is relatively shorter. Therefore, it is a main subject for related manufacturers and designers to extend the service life and reduce the size of spot lights.

In recent years, the illumination industry has constant breakthroughs on the research of high-power light emitting diodes (LED), and many products related to the industrial lamps and using the high-power LED are introduced to the market. Since the LED has the advantages of high brightness, power saving, a long service life, and a small compact design, the production space can be reduced significantly. However, the major drawback is the optical attenuation of the industrial LED lamps for construction projects, since the high temperature produced by the LED will cause optical attenuations of the light emitting chip and result in a significant drop of brightness. Therefore, the lamps for construction that use LED as a light emitting source usually comprises a main body, a plurality of heat sinks, a plurality of LED light sources and a transparent plate, wherein the main body includes a plurality of fixing slots formed on the same side of the main body and provided for installing the heat sinks, and each heat sink includes at least one fin, and the LED light sources are fixed into the fixing slots and contacted with the heat sinks respectively. The heat sinks can expedite the dissipation of the heat generated by the LED light sources to reduce or eliminate the optical attenuation, so as to achieve the effects of extending the service life and reducing the volume.

However, the industrial lamp using the LED light source still requires external power supply, thus still having inconvenience in mobility. During its use, it is necessary to find a mount frame to secure the lamps. Obviously the conventional LED lamp requires improvements, particularly for the lamps used in different construction sites or other maintenance and repair works.

In view of the aforementioned drawbacks, the present invention provides an LED lamp structure for construction comprising a housing, an LED lamp and a stand, wherein the housing has a compartment for containing the LED lamp and the stand, and the housing includes a built-in power supply installed therein for supplying the required electric power to the LED lamp. Therefore, the present invention has the advantage of accommodating the LED lamp and the stand in the housing to improve the mobility. In addition, the LED lamp and the stand can be removed and then combined to form a temporary mount frame, so as to reduce the level of difficulty of the installation and improve the convenience of use significantly. The present invention further adopts a built-in power supply system, so that users need not to find an external electric power source for using the LED lamp, and thus the invention is suitable for the use in a temporary construction project or a site that is changed frequently.

### SUMMARY OF THE INVENTION

In view of the shortcomings of the prior art, it is a primary objective of the present invention to provide an LED lamp structure for construction, wherein a housing is provided for accommodating an LED lamp and a stand to achieve an easy mobility, and the LED lamp and the stand can be combined to form a mount frame for adjusting the height, angle and direction of the LED lamp as well as improving the convenience of use.

Another objective of the present invention is to an LED lamp structure for construction having a built-in power supply to supply the electric power required by the LED lamp, and thus users can use the LED lamp anytime without a need of using an external electric power (such as a plug or an electric box) to extend the scope of applications.

To achieve the aforementioned objective, the present invention provides an industrial LED lamp, comprising: a housing, having at least one compartment and a built-in power supply, and the compartment formed on a side of the built-in power supply, and the built-in power supply having a first connecting portion; at least one LED lamp, disposed in the compartment, and having a second connecting portion electrically coupled to the first connecting portion, for driving the LED lamp to light up; and a stand, disposed in the compartment, and having a platform at an end of the stand, and a plurality of support legs at the other end of the stand.

When the LED structure of the present invention is stored or used, the housing is provided for accommodating the LED lamp and the stand to achieve an easy mobility, and after the LED lamp and the stand are combined, a temporary mount frame is formed, not only reducing the level of difficulty of the installation, but also improving the convenience of use significantly. In addition, the present invention adopts the built-in power supply without requiring an external electric power source, so that the LED lamp with the built-in power supply can be used anytime and anywhere to fit different occasions that require a high-power illumination.

To facilitate the carry, storage and use of the LED lamp, the housing comprises a chassis and a cover, and a side of the chassis and a side of the cover are pivotally coupled to each other, so that the cover and the chassis can be engaged with each other, and the housing further includes a lock for locking the chassis and the cover and effectively preventing components of the LED lamp from being collided or damaged.

To improve the convenience of use and assure a sufficient power level of the built-in power supply anytime, the built-in power supply can be used for charging or recharging a battery, and the built-in power supply includes a charging plug, and the built-in power supply is one selected from the collection of a lithium-iron battery, a lithium polymer battery, a lead-acid battery, a nickel-cadmium battery, a Ni-MH battery, a lithium cobalt battery and a lithium-manganese battery.

Wherein, the LED lamp of the present invention includes a lamp holder, a plurality of LED light emitting sources disposed on a side of the lamp holder and electrically coupled to the second connecting portion, and a transparent protective cover mounted onto a side of the LED light emitting sources. In addition, the lamp holder includes a mount frame disposed on the other side of the lamp holder and provided for installing on the platform of the stand, so as to enhance the convenience of installation and use significantly.

To facilitate adjusting the height and improve convenience of storage, the stand further includes a telescopic portion coupled between the platform and the support legs and provided for adjusting the height of the stand, such that users can pull or press the telescopic portion to adjust the stand to an appropriate height and reduce the storage volume effectively.

### BRIEF DESCRIPTION OF THE DRAWINGS

FIG. 1 is a schematic view of an LED lamp structure in accordance with a preferred embodiment of the present invention;

FIG. 2 is a schematic view of an LED lamp structure at a storing status in accordance with a preferred embodiment of the present invention;

FIG. 3 is a schematic view of an LED lamp structure at a using status in accordance with a preferred embodiment of the present invention; and

FIG. 4 is a schematic view of LED lamps in accordance with a preferred embodiment of the present invention.

### DETAILED DESCRIPTION OF THE PREFERRED EMBODIMENTS

The technical characteristics of the present invention will become apparent with the detailed description of a preferred embodiment accompanied with the illustration by related drawings as follows.

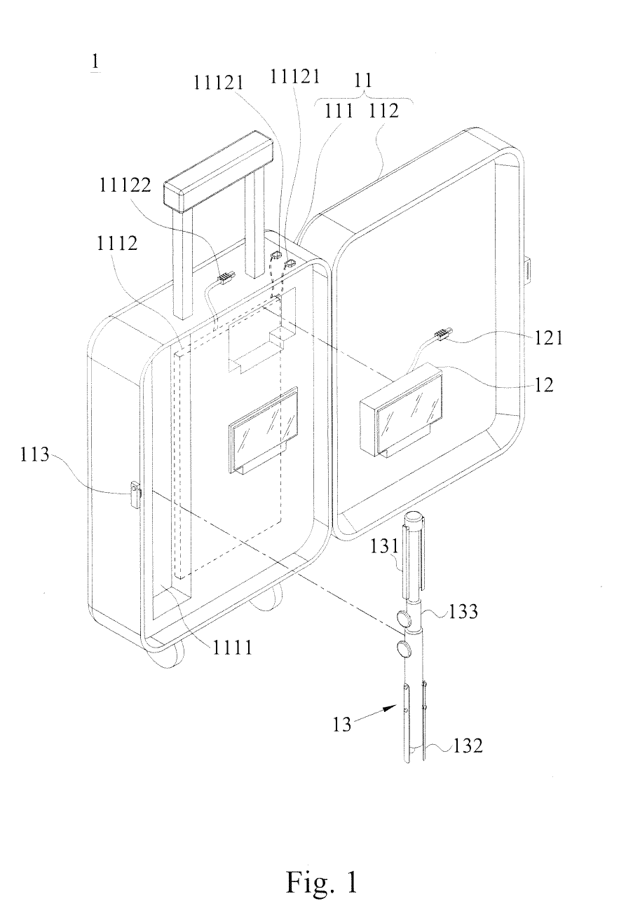

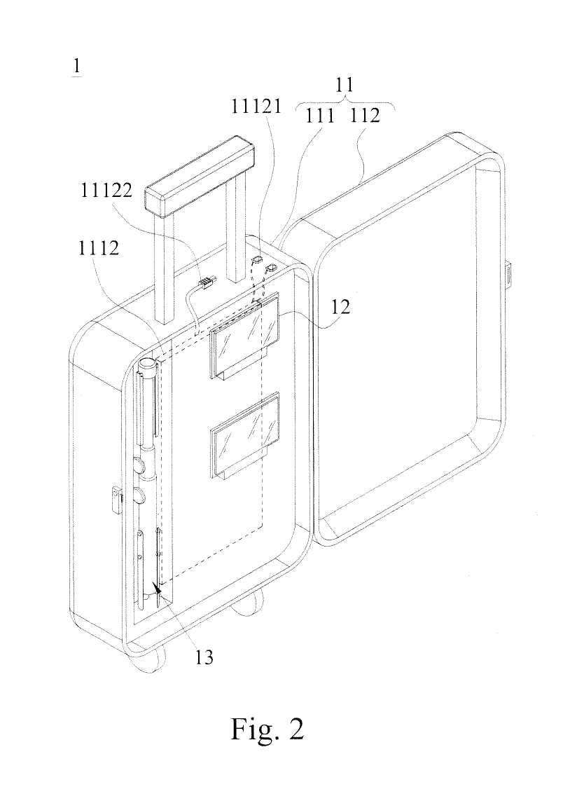

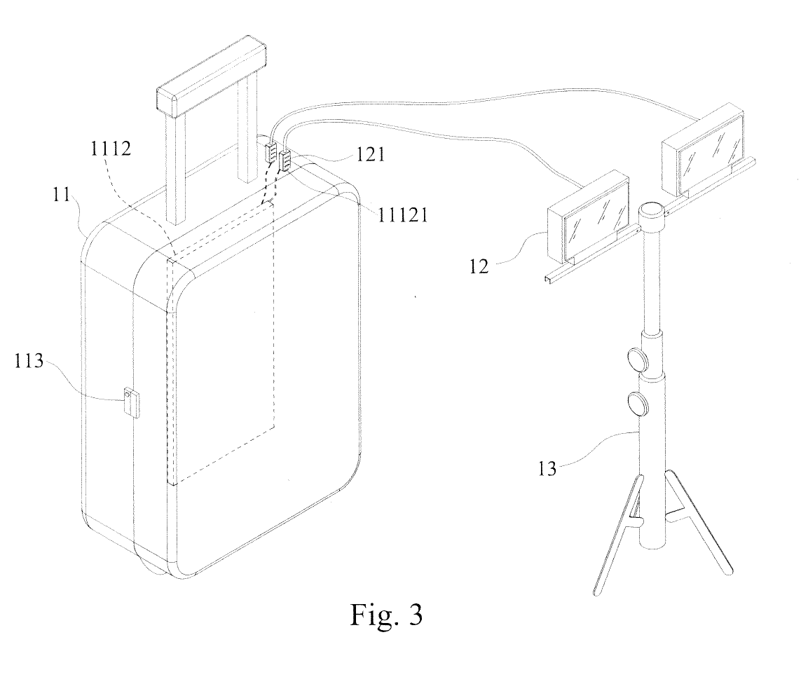

With reference to FIGS. 1 to 3 for schematic views of an industrial LED lamp at a storing status, and the structure at a using status in accordance with the present invention respectively, the industrial LED lamp 1 comprises a housing 11, an LED lamp 12 and a stand 13.

Wherein, the housing 11 includes a chassis 111 and a cover 112, and a side of the chassis 111 and a side of the cover 112 are pivotally coupled with one another, such that the cover 112 and the chassis 111 can be engaged with each other, and a lock 113 is installed on another side of the housing 11 and provided for locking the chassis 111 and the cover 1112. In addition, the chassis 111 includes a compartment 1111 and a built-in power supply 1112 therein, and the compartment 1111 is disposed on a side of the built-in power supply 1112, and the built-in power supply 1112 has a first connecting portion 11121. It is noteworthy to point out that the built-in power supply 1112 is a rechargeable battery, and the built-in power supply 1112 includes a charging plug 11122, and the built-in power supply 1112 is one selected from the collection of a lithium-iron battery, a lithium polymer battery, a lead-acid battery, a nickel-cadmium battery, a Ni-MH battery, a lithium cobalt battery and a lithium-manganese battery.

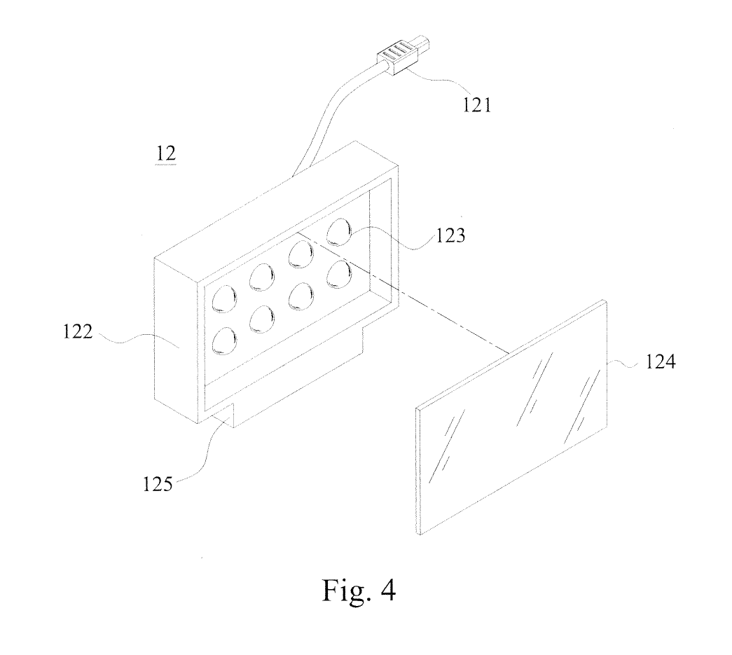

The LED lamp 12 is disposed in the compartment 1111 and includes a second connecting portion 121 electrically coupled to the first connecting portion 11121 to drive the LED lamp 12 to light up. With reference to FIG. 4 for a schematic view of LED lamps in accordance with a preferred embodiment of the present invention, the LED lamp 12 comprises a lamp holder 122, a plurality of LED light emitting sources 123 disposed on a side of the lamp holder 122 and electrically coupled to the second connecting portion 121, a transparent protective cover 124 mounted onto a side of the LED light emitting sources 123, and a mount frame 125 disposed on another side of the lamp holder 122.

The stand 13 is also disposed in the compartment 1111 and adjacent to a side of the LED lamp 12, and has a platform 131 disposed at an end of the stand 13 and a plurality of support legs 132 disposed at another end of the stand 13. To improve the effect for an operator to adjust the height effectively, the stand 13 further includes a telescopic portion 133 coupled between the platform 131 and the support legs 132 and provided for adjusting the height of the stand 13. When the LED lamp is used, the stand 13 can be pulled up or down to adjust the stand 13 to an appropriate height, and when the LED lamp is stored, the storage volume can be reduced effectively.

Therefore, when the industrial LED lamp 1 of the present invention is used, the LED lamp 12 and the stand 13 can be removed from the housing 11, and the mount frame 125 of the LED lamp 12 is connected to the platform 131 of the stand 13, and the first connection portion 11121 of the built-in power supply 1112 is provided for electrically coupling the second connecting portion 121 of the LED lamp 12. On the other hand, after the stand 13 is retracted and stored, the volume can be reduced, so that the stand 13 together with the LED lamp 12 can be placed into the compartment 1111 to facilitate the use, installation and storage.

In summation of the description above, the LED lamp structure for construction 1 of the present invention accommodates the LED lamp 12 and the stand 13 by the compartment 1111 of the housing 11, and the built-in power supply 1112 is installed in the housing 11, so that all components are accommodate in the housing 11 to provide an easy mobility. In addition, the LED lamp 12 and the stand 13 can be removed and then combined to form a temporary mount frame, so as to make it easy to set up the LED lamp, unlike the conventional lamps for construction that requires a disposing location and a mount frame. Thus, the invention can achieve the effects of reducing the level of difficulty for the installation, enhancing the convenience of use, and adjusting the angle, height or direction. In addition, the built-in power supply 1112 of the present invention can provide the electric power required by the LED lamp 12 without the need of finding an external electric power source, so that the invention can be used extensively for different application sites.

While the invention has been described by means of specific embodiments, numerous modifications and variations could be made thereto by those skilled in the art without departing from the scope and spirit of the invention set forth in the claims.

What is claimed is:

1. An industrial light emitting diode (LED) lamp, comprising:
a housing, having at least one compartment and a built-in power supply, and the compartment formed on a side of the built-in power supply, and the built-in power supply having a first connecting portion;
at least one LED lamp, disposed in the compartment, and having a second connecting portion electrically coupled to the first connecting portion, for driving the LED lamp to light up; and
a stand, disposed in the compartment, and having a platform at an end of the stand, and a plurality of support legs at the other end of the stand.

2. The industrial LED lamp as recited in claim 1, wherein the housing comprises a chassis and a cover and a side of the chassis and a side of the cover are pivotally coupled to each other, so that the cover and the chassis are engaged with each other.

3. The industrial LED lamp as recited in claim 2, wherein the housing further includes a lock for locking the chassis and the cover.

4. The industrial LED lamp as recited in claim 1, wherein the built-in power supply is a rechargeable battery, and the built-in power supply includes a charging plug.

5. The industrial LED lamp as recited in claim 4, wherein the built-in power supply is one selected from the collection of a lithium-iron battery, a lithium polymer battery, a lead-acid battery, a nickel-cadmium battery, a Ni-MH battery, a lithium cobalt battery and a lithium-manganese battery.

6. The industrial LED lamp as recited in claim 1, wherein the LED lamp includes a lamp holder, a plurality of LED light emitting sources disposed on a side of the lamp holder and electrically coupled to the second connecting portion, and a transparent protective cover mounted onto a side of the LED light emitting sources.

7. The industrial LED lamp as recited in claim 6, wherein the lamp holder includes a mount frame disposed on another side of the lamp holder and provided for installing on the platform of the stand.

8. The industrial LED lamp as recited in claim 1 wherein the stand further includes a telescopic portion coupled between the platform and the support legs and provided for adjusting the height of the stand.
